(19) United States
(12) Patent Application Publication
(10) Pub. No.: US 2007/0282731 A1
(43) Pub. Date: Dec. 6, 2007

(54) Pension support fund

(76) Inventor: Eric-Vincent Guichard, Washington, DC (US)

Correspondence Address: MCKENNA LONG & ALDRIDGE LLP, 1900 K STREET, NW, WASHINGTON, DC, 20006, US

(21) Appl. No.: 11/797,218

(22) Filed: May 1, 2007

Related U.S. Application Data
(60) Provisional application No. 60/795,729, filed on May 1, 2006.

(51) Int. Cl. G06Q 40/00

(52) U.S. Cl. 705/36 R

(57) ABSTRACT

A pension support fund provides disintermediation between capital markets and a pension fund whose credit rating is so poor it cannot access the capital markets on its own. The pension support fund, having a high credit rating (for example, AAA) facilitates access to capital on a non-recourse basis, and provides principal insurance such that capital invested is protected at term. Furthermore, it facilitates the creation of domestic investment vehicles in local currency to facilitate achieving liability hurdle rates of return—thereby hedging against long term liabilities.

This application claims the benefit of U.S. Provisional Patent Application No. 60/795,729, filed on May 1, 2006, which is hereby incorporated by reference for all purposes as if fully set forth herein.

### BACKGROUND OF THE INVENTION

1. Field of the Invention

The present invention relates to a pension support fund (the PSF), which is an structured pension funding and investment arrangement targeted at sovereign and corporate pension funds with limited or no access to capital markets.

2. Discussion of the Related Art

A number of trends are common across pension funds worldwide. First, pension funds have large unfunded liabilities that are growing. Second, the pension funds have an average actuarial hurdle in region of about 8%, meaning that funds' investments must return on average about 8% to meet their payout obligations, though that varies from fund to fund and will vary in time. In addition, pension funds in emerging markets face considerable budget constraints and have a minimal if not zero access to capital from which they can borrow to invest or meet their obligations in the face of exogenous factors.

In developed countries, such as those in the Organization of Economically Developed Countries (OECD), the populations tend to be older and are thus are putting stress on pensions funds already. When pension funds in these countries can access the capital markets, they can generally meet their obligations through prudent investment of the funds assets. If pension funds are limited in the assets they can invest in, then they may have difficulty meeting their obligations.

In emerging markets (non-OECD countries, such as countries in Africa, Asia, and South America, for example), the demographic situation provides one advantage. The populations are generally younger and have a growing middle class, which means the bulk of the payout obligations of the pension funds will not occur for many years. However, problems lie in the fact that these non-OECD countries typically have limited access to international capital markets (the capital markets of OECD countries, or “hard currency” markets). In addition, while domestic liquidity is high, meaning they are flush with local currency, these funds have no place to invest those funds because of their limited or non-existent access to capital markets.

FIG. 1 illustrates how pension funds in OECD markets can access capital to enhance yields. The pension fund 104 (a conventional pension fund) is obligated to pay a principal amount to beneficiaries 108 at some point in the future. The pension fund can access additional capital on the capital markets 102 by issuing a pension obligation bond (“POB”) to investors. The proceeds of these POB sales are invested along with the fund's assets in an investment portfolio 106. The portfolio 106 returns some positive rate of return in a hard currency. The return on portfolio 106 is enough to both pay back the capital borrowed or obligated to the capital markets and also increase the assets of the pension, so that by the time the pension 104 is required to pay the beneficiaries 108, the pension 104 has the assets to do so.

FIG. 2 illustrates how the process breaks down for pension funds in non-OECD countries, corporate pensions which are limited by corporate credit ratings, or non-corporate pensions in emerging markets limited by sovereign ratings. The fund's or sovereign's poor credit rating effectively forecloses access to the international/hard-currency capital markets. The reason is that while in OECD countries credit ratings are assigned based on risk and can access capital on the capital markets at interest rates (the cost of capital) commensurate with the risk represented by that rating, excessive risk, or credit ratings below a certain threshold that are often assigned to non-OECD countries cannot access the capital markets at any rate of interest—banks and lenders simply will not lend the money. Therefore, the pension fund of non-OECD countries cannot issue pension obligation bonds, and have no high return or low risk investments available to include in their portfolio.

Because of this, the portfolio 206 into which the pension 204 can invest has limited diversification, low yield, or a very limited pool of investments from which to choose. Because portfolio 206 is either non-existent or has very low returns with high risk, the pension fund 204 will not earn enough annual return on the portfolio 206 to be able to meet its principal obligation to the beneficiaries 208. Typically, in order to access capital, these pension funds in emerging markets must resort to the public sector or international organizations for solutions in the form of loans or aid. However, these public sector funds routinely come with restrictions, often onerous, on how the funds can be spent.

What is needed is a private sector solution free from these requirements that achieves actuarial hurdles over a longer time horizon than that of OECD countries. The 8% hurdle is typically represented in U.S. dollars, which corresponds to 10%-12% in local currency. It should also allow the pension fund to increase its capital base efficiently to enhance yields.

### SUMMARY OF THE INVENTION

Accordingly, the present invention is directed to a pension support fund that substantially obviates one or more of the problems due to limitations and disadvantages of the related art.

An advantage of the present invention is to provide access to capital markets at favorable or minimal costs of capital. Other advantages of the present invention are conversion of the pension fund to a different asset class, leverage in the form of negotiated loan arrangements with banks, diversification of investments, risk-reducing and return enhancing asset allocations, and principal protection and pricipal guarantee at term.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of structuring an investment and the structured financial arrangement having a fund into which a principal amount is invested; a portfolio managed by said fund into which said principal amount is invested, said portfolio including a plurality of assets, each of said assets having a credit rating and a rate of return, wherein an overall credit rating of the portfolio is AAA and the rate of return is positive; and a loan obtained by said fund equal to a fraction or a multiple of said principal, said principal being collateral for said loan, wherein said principal is insured against loss; wherein the loan is invested in said portfolio in addition to said principal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates the relationship between pension funds and capital markets in OECD countries;

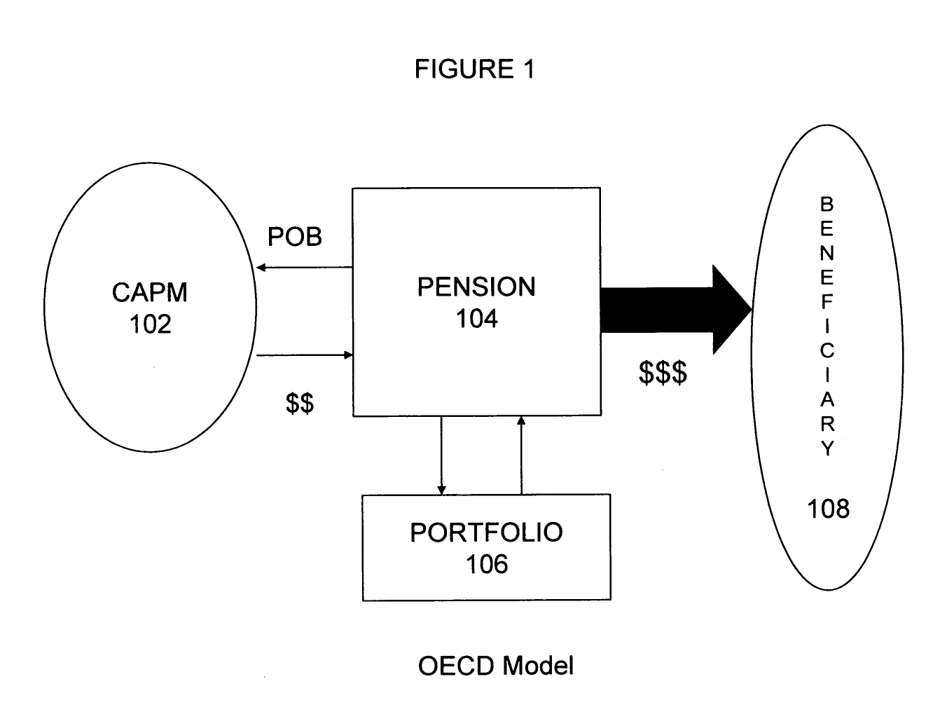

FIG. 2 illustrates the relationship between pension funds and capital markets in non-OECD countries; and

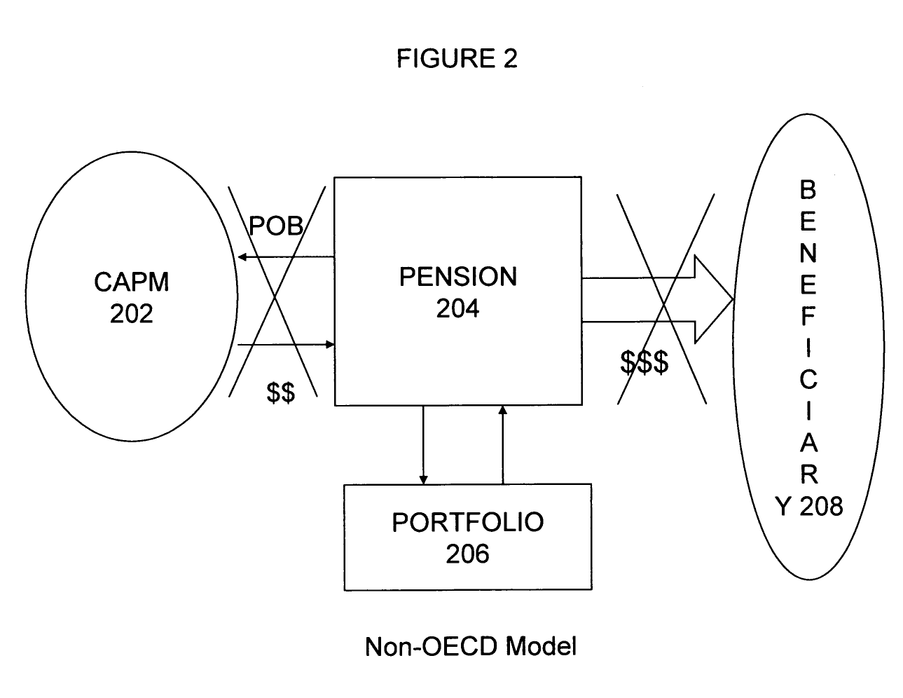

FIG. 3 illustrates the structure and method of the present invention.

FIG. 4 illustrates an exemplary portfolio structure according to the present invention.

### DETAILED DESCRIPTION OF THE ILLUSTRATED EMBODIMENTS

Reference will now be made in detail to an embodiment of the present invention, example of which is illustrated in the accompanying drawings.

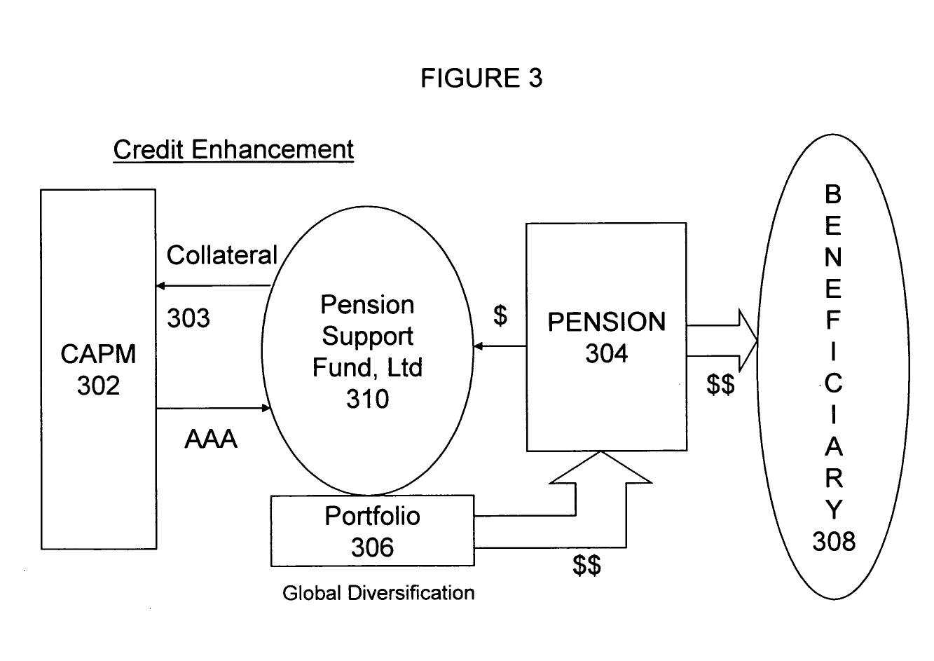

FIG. 3 illustrates the method of the present invention. The pension 304 having obligations to pay a principal amount to beneficiaries 308 in the future invests its present assets in the pension support fund 310. The pension support fund 310 provides disintermediation between the capital markets and the pension fund whose credit rating is so poor it cannot access the capital markets on its own. The pension support fund 310 having a high credit rating (for example, AAA) facilitates access to capital on a non-recourse basis, and provides principal insurance such that capital invested is protected at term. Furthermore, it facilitates the creation of domestic investment vehicles in local currency to facilitate achieving liability hurdle rates of return—thereby hedging against long term liabilities.

The pension support fund buys principal insurance for various periods (5 yr., 7 yr. and 10 yrs.) such that the capital invested is principal insured at term. In other words, when the pension 304 invests in the pension support fund 310 (by buying a bond or note sold by the pension support fund) the pension support fund uses the principal invested to purchase principal insurance for the term. Doing so, the pension support fund negotiates preferential capital access terms that facilitate invested pension 304's ability to achieve positive yield spreads. The pension support fund uses this insured principal as collateral to borrow money at a low cost of capital (because the insurance gives it a high credit rating) and on preferential terms from the capital markets 302. The borrowed amount allows the pension support fund 310 to leverage the original principal by investing both in a portfolio 306 that is risk-managed and has a moderate to high rate of return. Returns on the portfolio 306 are return to the pension, but more importantly, as the net assets of the pension in the pension support fund grow, the amount borrowed from the capital markets 302 increases as well, creating greater leverage.

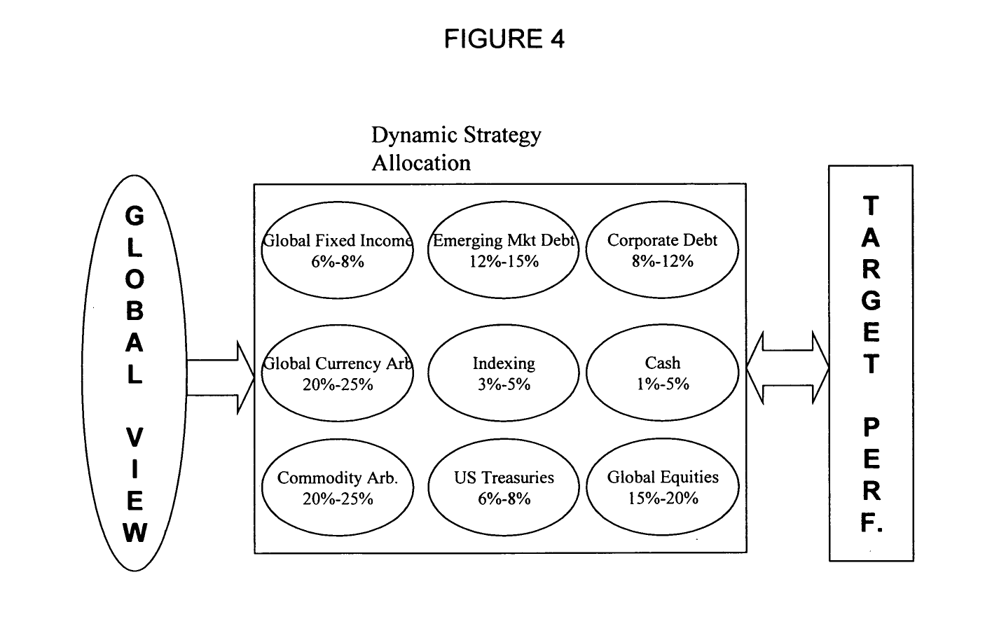

In order to be able to obtain the principal insurance and access the capital markets on preferential terms, the portfolio is carefully structured and managed to reduce risk. FIG. 4 shows an example of a portfolio 306. In FIG. 4, the portfolio 306 is in fact a fund of funds selected from a variety of asset classes, credit ratings and returns. High-risk investments such as a global currency arbitration fund have a corresponding higher rate of return. Lower risk vehicles such as index funds and cash have lower returns. By carefully selecting the overall mix, the risk of principal loss of the entire portfolio is reduced while increasing returns. In other example, the portfolio could be a collection of private equity funds. In general, the pension support fund focuses on tactical asset allocation across a wide set of asset classes which enable it to mitigate risks. The pension and insurance clients are invested, through pension support fund, in high-grade investment instruments that have capital insurance and provide access to a multitude of underlying asset classes structured to achieve target hurdle rates.

In practice, the structure of this investment can be establish a number of different ways. For example, each of the assets in FIG. 4 could take the form of a structured note negotiated by the pension support fund with a bank. The bank lends the pension support fund an amount equal to a fraction or multiple of the pension support fund's assets invested, considering the fund's assets as collateral for the loan. For example, if the fund invests one dollar in the underlying asset, the bank will lend less than, equal to, or more than a dollar to the fund at the bank's cost of capital. In one example, assume a pension having an actuarial hurdle of 8% invests $1 in the fund. If in this example the bank lends at a 1:1 ratio (lends one dollar or ever dollar invested), the bank will lend the fund $1 (in other example the ratio may be fractional, i.e. less than one, or a multiple, i.e. greater than one). The fund is able to invest this dollar along with its own in the asset (for a total of $2), which by way of example is a stock fund. If the stock fund asset's return after one year is 10%, the pension support funds assets grow to $2.2 from $2. If the cost of capital (the bank's interest rate on the $1 loan) is 4%, the pension support fund pays back the original principal borrowed plus interest, or $1.04, leaving the fund with $1.16, or a 16% return. After one year, the actuarial hurdle is only $1.08. In the next year, assuming a 1:1 ration, the fund can borrow another $1.16 from total available to invest of $2.32.

Depending on the lending arrangement between the bank and the fund, there may be fees which will reduce the return slightly. Nonetheless, over time the assets of the fund will grow substantially beyond the actuarial hurdle due to this leverage and the compounding effect.

In alternate embodiments of the invention, each asset may be subject to a different lending arrangement with a different bank. This creates diversification not only of assets and assets classes, but also diversification across banks having different cash and lending profiles.

Because of (a) the leverage offered by the pension support fund through capital from the capital markets 302 made possible by the principal insurance and (b) the carefully managed risk-return profile of the portfolio 306, the pension support fund can provide returns to non-OECD pension funds above the actuarial hurdle and provide principal protection so that obligations to beneficiaries of the pension are met at term. Thus, the pension support fund is a conduit through which pension funds with unfavorable credit ratings can access the capital markets to meet their future obligations where those ratings would normally deny the funds access to the capital markets. It provides a private sector solution for emerging market funds without imposing onerous requirements on the fund or their sovereigns.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of structuring an investment, comprising:
a fund having a principal amount invested therein;
a portfolio managed by said fund into which said principal amount is invested, said portfolio including a plurality of assets, each of said assets having a credit rating and a rate of return, wherein an overall credit rating of the portfolio is AAA and the rate of return is positive; and
a loan obtained by said fund equal to a fraction of said principal, said principal being collateral for said loan,
wherein said principal is insured against loss; and
wherein the loan is invested in said portfolio in addition to said principal.
